(19) United States
(12) Patent Application Publication
(10) Pub. No.: US 2022/0295749 A1
(43) Pub. Date: Sep. 22, 2022

(54) Dogs toilet

(71) Applicant: Orville Lewis Mignott, Hollywood, FL (US)

(72) Inventor: Orville Lewis Mignott, Hollywood, FL (US)

(21) Appl. No.: 16/974,372

(22) Filed: Mar. 19, 2021

(51) Int. Cl. A01K 27/00; A01K 23/00

(52) U.S. Cl. CPC A01K 27/002; A01K 23/00

(57) ABSTRACT

The present invention comprises a novel waste collection harness secured to the dog's body using Velcro straps that run under the dog's abdomen until secured using a Velcro latch. The harness starts at the base of the dog's neck and wraps around the dog's rear and is secured under the abdomen immediately before the hind legs. The invention embodies an elliptical opening, through which the dog's tail and anus is exposed. Directly beneath the tail is a coiled waste disposable bag that is secured to the elliptical opening and collects excreted waste. Once fecal matter is collected, the disposable waste bag can be quickly unsecured, sealed and discarded.

### FIELD OF INVENTION

This invention relates to harnesses designed for dogs of different sizes, and more particularly to a fecal waste collecting travel harness that enables dog owners to collect and dispose of dog waste without using the poop and scoop disposal method or having any direct contact with the dog's fecal waste.

### BACKGROUND

Dogs have long occupied a valued place in millions of households around the world. Having domesticated dogs, who currently serve as service pets, family pets, or guard dogs, there is an ever-growing need for dogs to be kept inside homes, offices, and public buildings for extended periods of time. Moreover, many pet owners grow so attached to their pets, that they frequently travel with them in cars, on long road trips, and even in airplanes. Although domesticated, dogs lack an ability to excrete fecal waste in a designated place. In fact, dog owners will exclaim their frustration with dogs excreting waste at any time they have an urge to do the same; often on a sidewalk or public location, where local Pooper Scooper Laws require them to collect and properly discard of dog fecal waste.

As a result, many dog owners have to travel with poop collection bags, clean dog fecal waste off sidewalks, collect and dispose of fecal waste left in grass, and other public areas. When traveling with dogs, many pet owners frequently stop and disrupt their travel plans in order to avoid accidents. Moreover, many pet owners love their animal partners, but despise collecting and discarding of their waste.

Therefore, there is an existing need in the field for a novel waste collection travel harness, capable of collecting dog waste in a manner that pet owners can easily dispose of without any direct interaction or contact with animal fecal waste.

### BRIEF SUMMARY OF THE INVENTION

This invention comprises of a novel dog harness that is placed on the dog's back and is secured under its belly or side with adjustable Velcro straps. The Travel Harness starts at the base of the dog's neck and is secured immediately behind the forelegs and shoulders. The harness runs along the length of the dog's back until the base of its tail. At the base of the tail, is an opening in the shape of an ellipse, through which the dog's tail is placed. The elliptical opening facilitates easy movement of the dog's tail and collection of fecal waste in an attachable disposal bag. The rear portion of the Travel Harness is secured with adjustable Velcro straps that runs from elliptical opening to adjoining Velcro straps located under the abdomen region. The rear straps are designed in a manner that does not infringe with the dog's ability to urinate—regardless of gender.

### BRIEF DESCRIPTION OF DRAWINGS

Some embodiments of this invention are illustrated as an example and are not limited by the figures of the accompanying drawings, in which like references may indicate similar elements and in which:

FIG. 1 is a left facing perspective view of the invention, waste collection travel harness device, illustrating a closed configuration.

FIG. 2 is a right facing perspective view of the invention, waste collection travel harness device, illustrating a closed configuration.

FIG. 3 is a left facing perspective view of the invention, waste collection travel harness device, illustrating an open configuration.

FIG. 4 is a right facing perspective view of the invention, waste collection travel harness device, illustrating a closed configuration.

FIG. 5 is an exploded right facing perspective view of the invention, waste collection travel harness, device, illustrating a open configuration. The Velcro straps are unsecured, demonstrating how the invention is secured around the dog's abdomen. FIG. 5 further demonstrates how the rear strap between the hindlegs and is secured beneath the abdomen.

FIG. 6 is a right facing perspective view of the rare of the invention, waste collection travel harness device, illustrating the elliptical opening through which the dog's tail is placed for free movement. FIG. 6 further illustrates the elliptical opening surrounding the dog's anus, the point at which a disposable waste bag will be secured to collect fecal waste excreted by the dog. FIG. 6 also demonstrates the oval opening commencing immediately beneath the elliptical opening where the fecal matter and tail is located, to the lower abdominal area where the rear Velcro straps are secured.

FIG. 7 is an exploded right facing perspective view of the invention, waste collection travel harness device, illustrating the elliptical opening at the base of the tail.

FIG. 8 is an exploded left facing perspective view of the invention, waste collection travel harness device, illustrating the elliptical opening at the base of the tail. FIG. 8 depicts the angled offset of the elliptical opening, which enables the flow of fecal matter into the disposable waste bag.

FIG. 9 is another perspective view of the invention, waste collection travel harness, illustrating the Velcro straps beneath the abdomen of the dog, in a closed configuration.

FIG. 10 is a top plan view of the invention, illustrating the straps and all embodiments of the invention in an open configuration.

FIG. 11 is an exploded right facing perspective view of the invention, illustrating the disposable waste bag being secured to the elliptical opening located at the base of the tail. FIG. 11(a) illustrates the disposable waste bag being in an unsecured configuration to the elliptical opening. FIG. 11(b) illustrates the disposable waste bag in a secured configuration to the elliptical opening.

FIG. 12 is an exploded right facing perspective view of the invention, illustrating the disposable waste bag attached to the elliptical opening located at the base of the tail in a closed configuration.

FIG. 13 is an exploded right facing perspective view of the invention, illustrating the disposable waste bag unattached to elliptical opening located at the base of the tail in an open configuration.

FIG. 14 is an exploded perspective view of the invention, illustrating the disposable waste bag in an open and unsecured configuration.

FIG. 15 is an exploded perspective view of the invention, illustrating the Velcro strap latch in a closed configuration, used to secure the device to the abdominal region of the dog.

### DETAILED DESCRIPTION OF THE INVENTION

The terminology used herein is for the purpose of describing particular embodiments only and is not intended to be limiting of the invention. As used herein, the term “and/or” includes any and all combination of one or more of the associated listed items. As used herein, the singular forms “a”, “an” and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Unless other defined, all terms (including technical and scientific terms) used herein have the same meaning as commonly understood by one having ordinary skills in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense, unless expressly so defined herein.

In describing the invention, it will be understood that a number of techniques and steps are disclosed. Each of these steps and techniques have individual benefits and each can also be used in conjunction with one or more, or in some cases, all of the other disclosed techniques. Accordingly, for the sake of clarity, this description will refrain from repeating every possible combination of the individual steps in an unnecessary fashion. Nevertheless, the specification and claims should be read with the understanding that such combination are entirely within the scope of the invention and the claims.

The waste collection travel harness device, apparatuses, and method for use are described herein. In the following description, for purposes of explanation, numerous specific details are set forth in order to provide a thorough understanding of the present invention.

The present disclosure is to be considered an exemplification of the invention, and is not intended to limit the invention to the specific embodiments illustrated by the figures or description below.

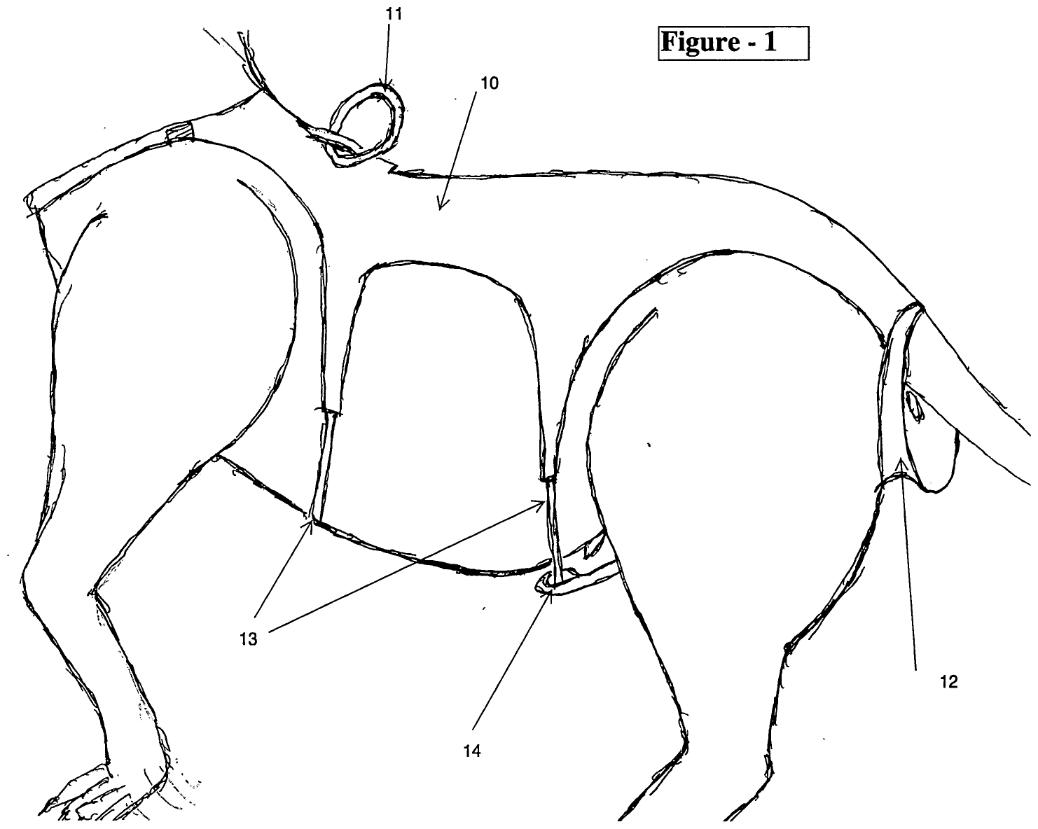

The present invention will be described by referencing the appended figures representing preferred embodiments. FIG. 1 is a left facing perspective view of the invention, waste collection travel harness device 10, illustrating a closed configuration. FIG. 1 depicts a circular ring 11 in a permanently affixed configuration, at the base of the neck through which a leash may be attached when walking the dog. The circular ring 11 may be made from metals or woven fabric. The invention 10 is secured to the dog's body using Velcro straps 13 that run from the left side of the dog's body, under the abdominal area to the right side. The rear Velcro strap 13 is located immediately before the hind legs. The rear Velcro strap 13 passes through a circular loop 14 located at the end of the invention 10. At the rear of the dog is a elliptical opening 12 through which the dog tail is placed and the excreted fecal waste is collected for disposal. The elliptical opening 12 may be made from fluoroelastomer, silicone rubber, butyl rubber, natural rubber, neoprene, ethylene propylene diene monomer (EPDM), or polyurethane.

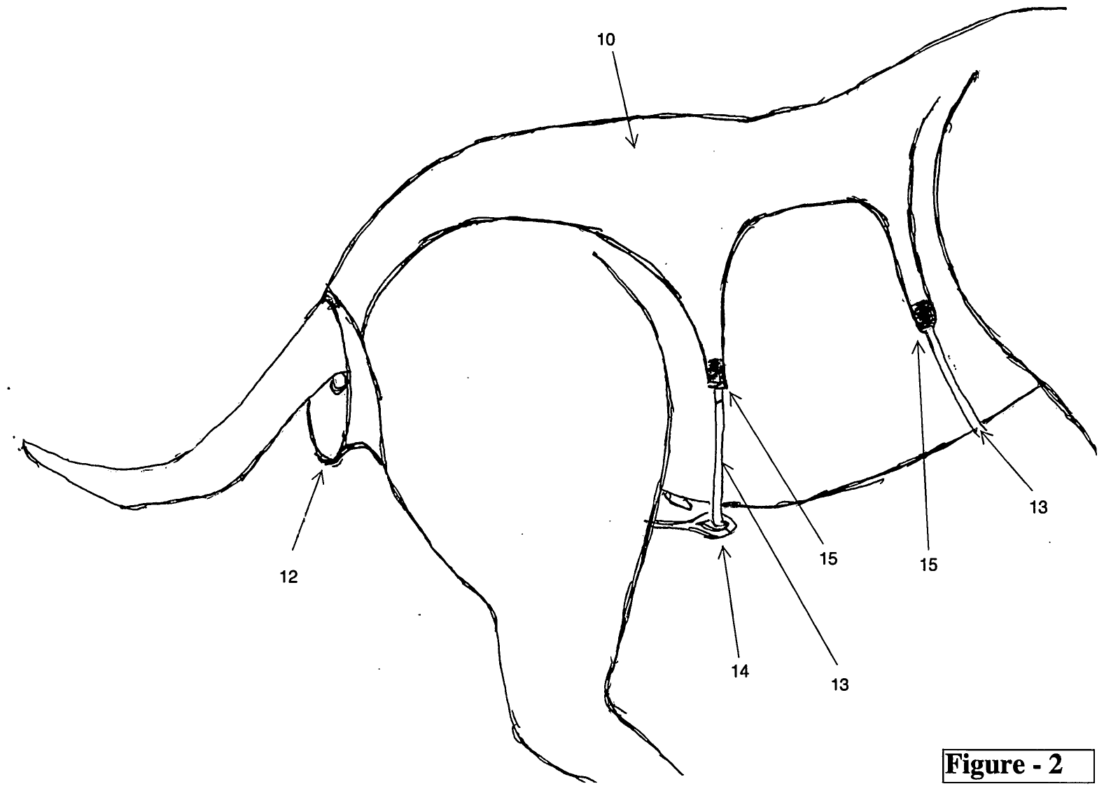

FIG. 2 is a right facing perspective view of the invention, waste collection travel harness device 10, illustrating a closed configuration. The invention 10 is secured to the dog's body using Velcro straps 13 that run from the left side of the dog's body, under the abdominal area to the right side. The rear Velcro strap 13 is located immediately before the hind legs. The rear Velcro strap 13 passes through a circular loop 14 located at the end of the invention 10. At the rear of the dog is a elliptical opening 12 through which the dog tail is placed and the excreted fecal waste is collected for disposal. The Velcro straps 13 are secured to the right side of the harness using an adjustable Velcro latches 15.

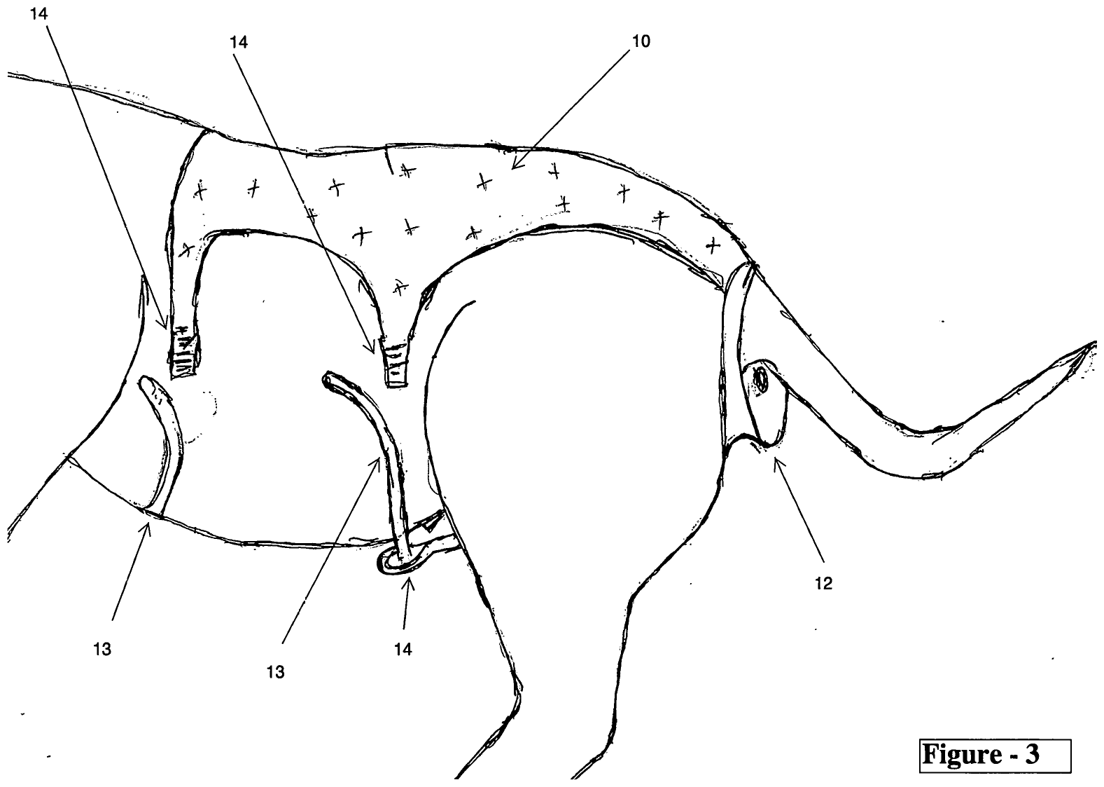

FIG. 3 is a left facing perspective view of the invention, waste collection travel harness device 10, illustrating an open configuration. The Velcro latches 15 are in an open configuration, resulting in the Velcro straps 13, being unsecured and removable. FIG. 3 further depicts how the Velcro strap 13, is passed through the circular loop at the end of the invention 10 in order to be connected to the Velcro latch 15.

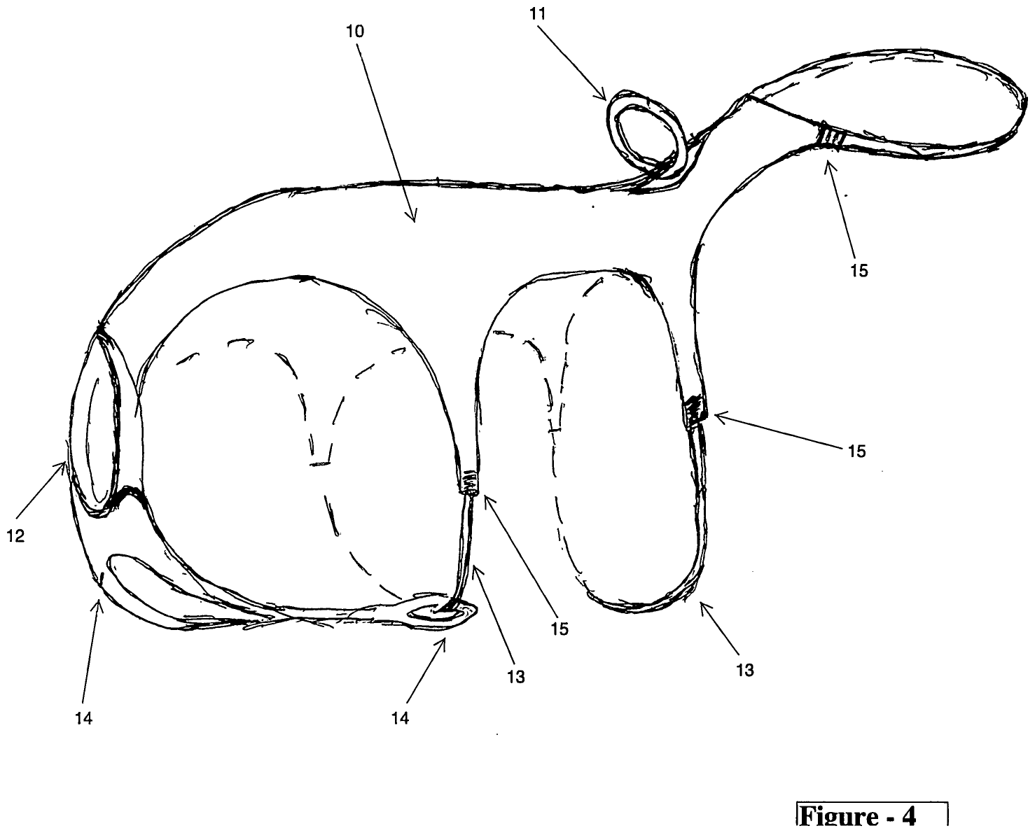

FIG. 4 is a right facing perspective view of the invention, waste collection travel harness device, 10 illustrating a closed configuration. FIG. 4 depicts the Velcro latch 15 used to secure the invention around the dog's neck.

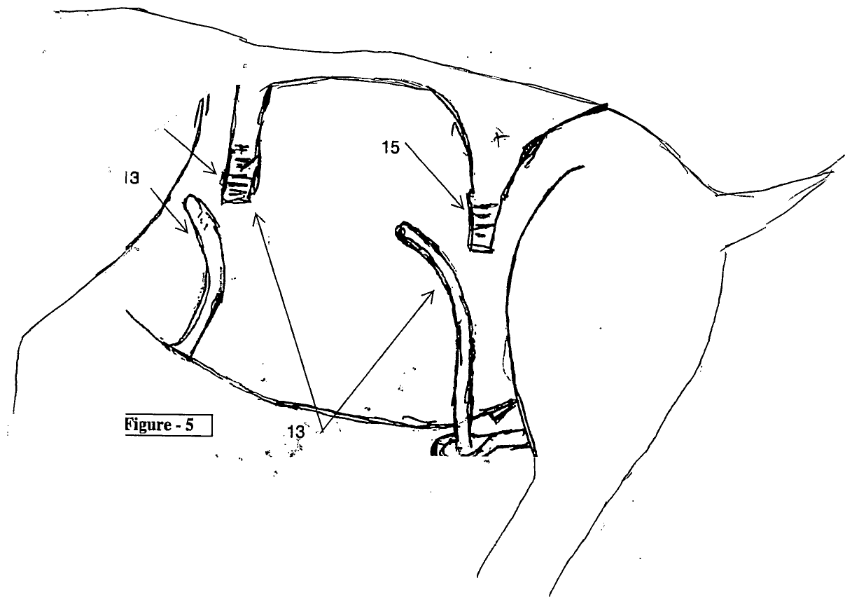

FIG. 5 is an exploded right facing perspective view of the invention, waste collection travel harness device 10, illustrating a open configuration. The Velcro straps 13 are unsecured, demonstrating how the invention is secured around the dog's abdomen. FIG. 5 further demonstrates how the rear strap 13, is secured around the abdomen using Velcro latches 15.

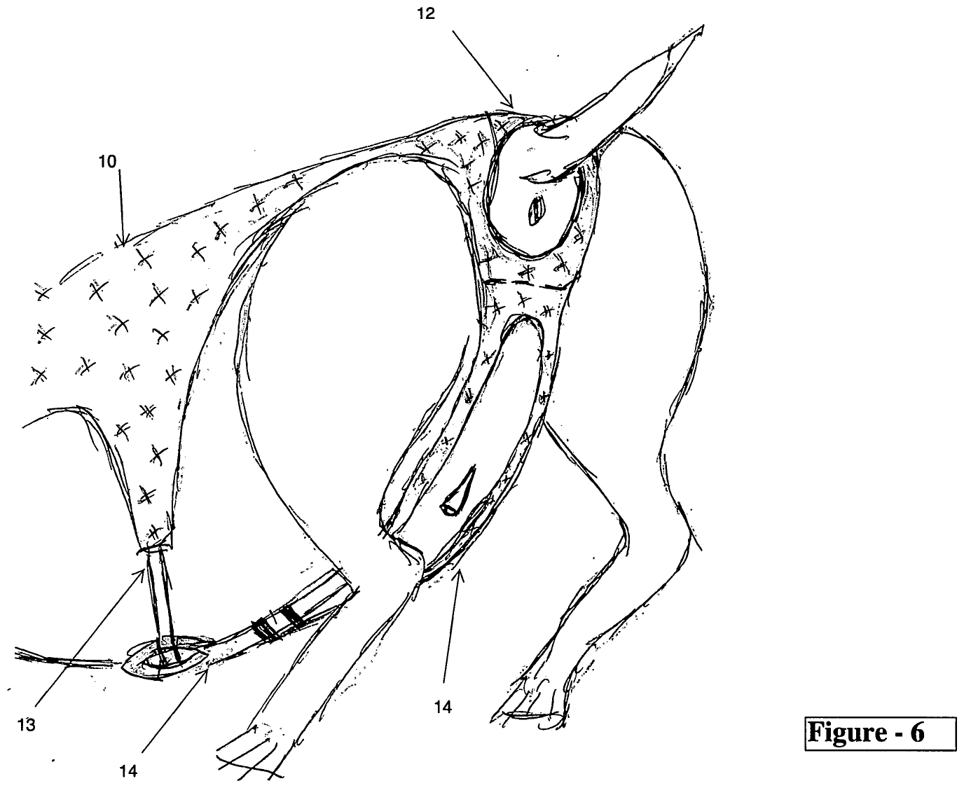

FIG. 6 is a right facing perspective view of the rare of the invention, waste collection travel harness device 10, illustrating the elliptical opening 12 through which the dog's tail is placed for free movement. FIG. 6 further illustrates the elliptical opening 12 surrounding the dog's anus, the point at which a disposable waste bag 16 will be secured to collect fecal waste excreted by the dog. FIG. 6 also depicts how the invention 10 is secured to the dog's body using a circular loop at the end of the invention 14, through which the rear Velcro strap 13 is passed through until secured in the Velcro latch 15 depicted in FIG. 5.

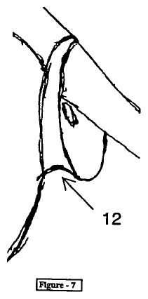

FIG. 7 is an exploded right facing perspective view of the invention, waste collection travel harness device 10, illustrating the elliptical opening 12 at the base of the tail.

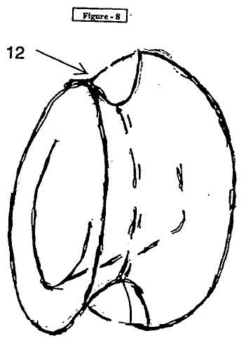

FIG. 8 is an exploded left facing perspective view of the invention, waste collection travel harness device 10, illustrating the elliptical opening 12 at the base of the tail. FIG. 8 depicts the angled offset of the elliptical opening 12, which enables the flow of fecal matter into the disposable waste bag.

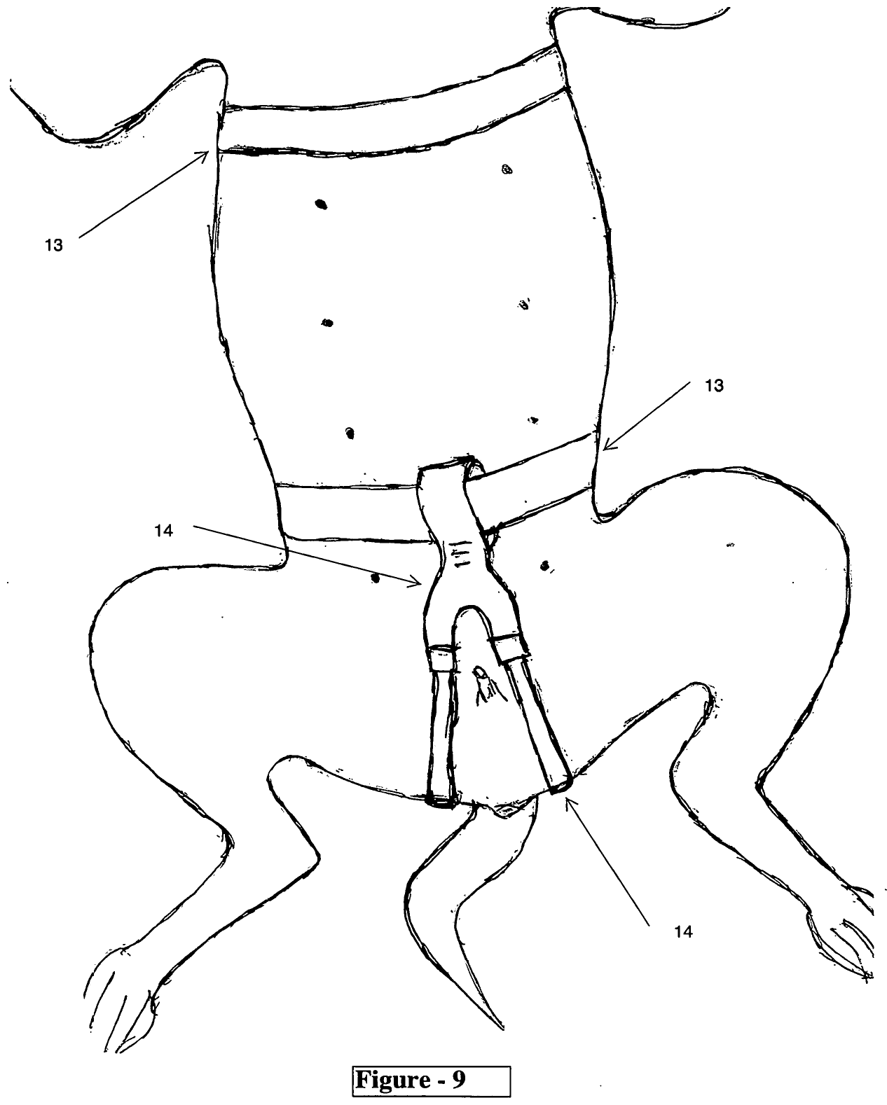

FIG. 9 is another perspective view of the invention, waste collection travel harness 10, illustrating the Velcro straps 13 beneath the abdomen of the dog, passing through the circular loop at the end of the invention 14 in a closed configuration.

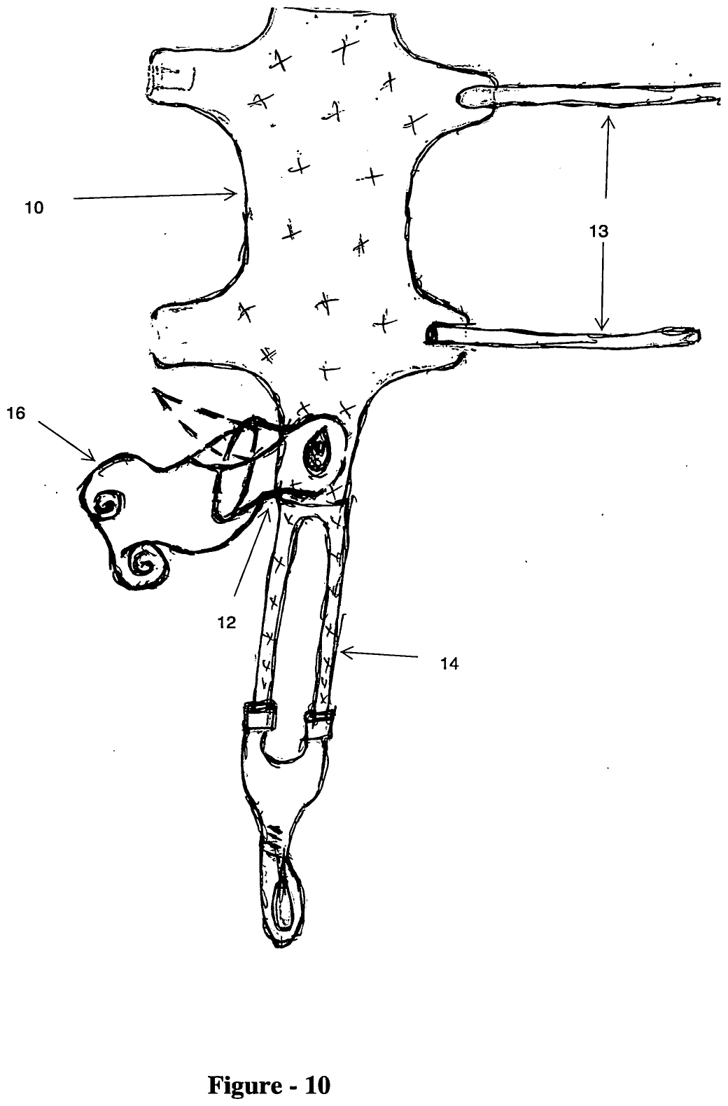

FIG. 10 is a top plan view of the invention 10, illustrating the Velcro straps 13 and all embodiments in an open configuration. FIG. 10 further depicts the elliptical opening 12 with the disposable waste bag 16 attached to the elliptical opening 12. The circular loop 14 at the end of the invention 10 is depicted in an open configuration.

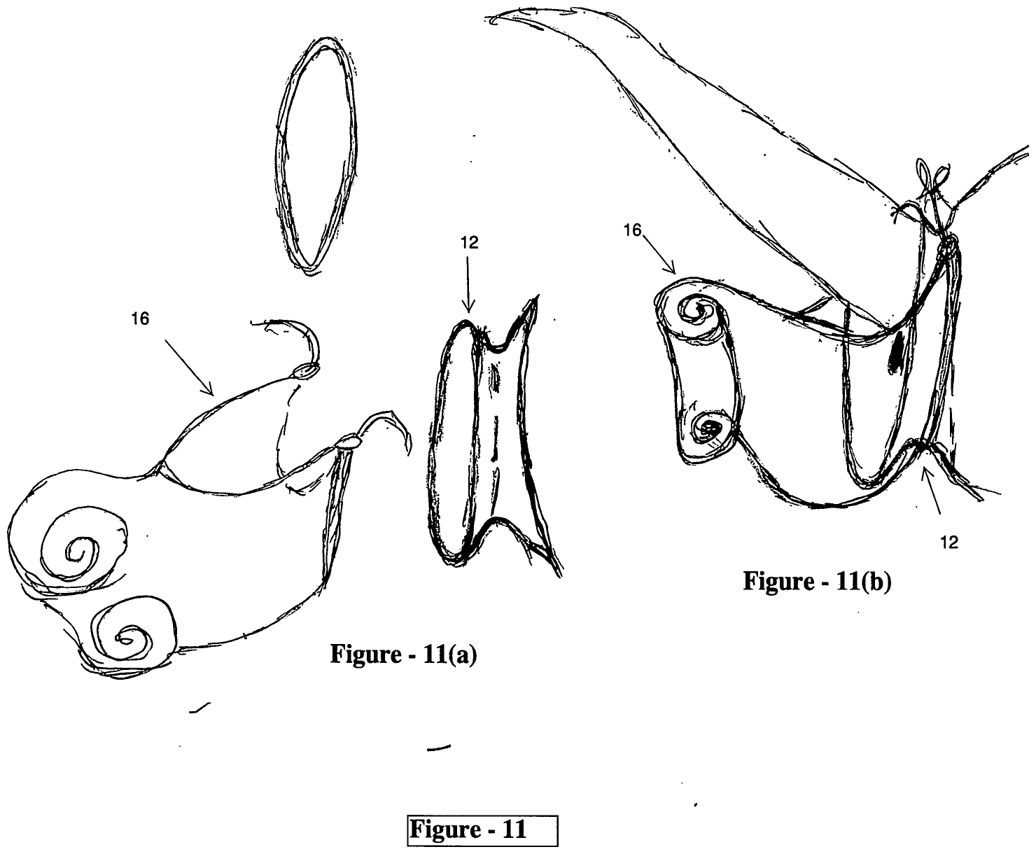

FIG. 11 is an exploded right facing perspective view of the invention 10, illustrating the disposable waste bag 16 being secured to the elliptical opening 12 located at the base of the tail. FIG. 11(a) illustrates the disposable waste bag 16 in an unsecured configuration to the elliptical opening 12. FIG. 11(b) illustrates the disposable waste bag in a secured configuration to the elliptical opening 12. The disposable waste bag

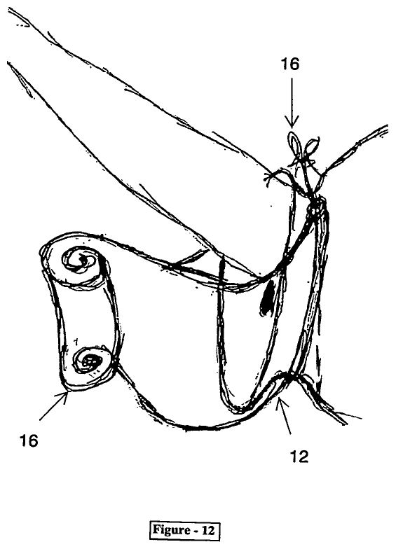

FIG. 12 is an exploded right facing perspective view of the invention 10, illustrating the disposable waste bag 16 attached to the elliptical opening 12 located at the base of the tail in a closed configuration. The disposable waste bag 16 is secured to the elliptical opening 12 by placing the disposable waste bag 16 beneath the elliptical opening 12, in order to wrap the disposable waste bag 16 around the elliptical opening 12, before securing the disposal waste bag 16 to the top of the elliptical opening 12. Once filled with fecal waste, the disposable waste bag 16 can be loosened and removed in the reverse order to how it was secured. The disposable waste bag 16 will be curled up in a closed configuration immediately under the tail. When fecal matter is excreted by the dog comes in contact with the disposable waste bag 16, the disposable waste bag 16 will unravel and open in order to collect the fecal waste. Once waste is collected in the disposable waste bag 16, the disposable waste bag 16 can be unsecured from the elliptical opening 12 and sealed to ensure sanitary and environmental disposal.

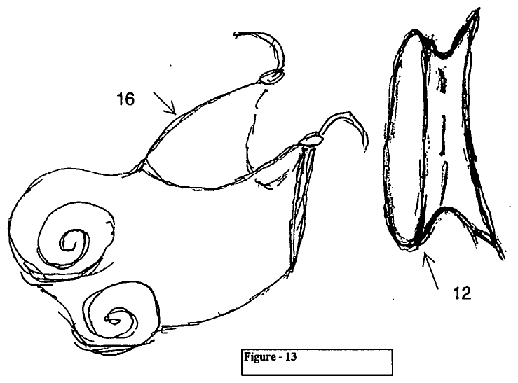

FIG. 13 is an exploded right facing perspective view of the invention 10, illustrating the disposable waste bag 16 unattached to elliptical opening 12 located at the base of the tail in an open configuration.

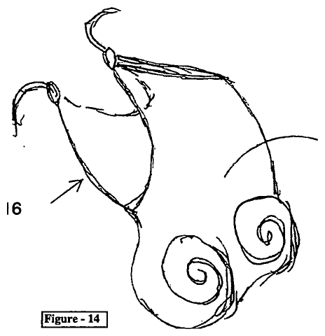

FIG. 14 is an exploded perspective view of the invention, illustrating the disposable waste bag 16 in an open and unsecured configuration. The disposable waste bag may be made from polyethylene plastic bags, mater-bi resin, or compostable polymer plastics.

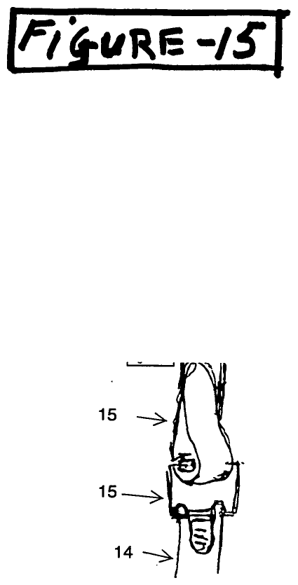

FIG. 15 is an exploded perspective view of the invention, illustrating the Velcro strap 14 fastened into the Velcro latch 15 in a closed configuration, used to secure the device to the abdominal region of the dog.

While preferred materials for each element have been described, the device or invention is not limited by these materials. Wood, plastics, rubber, foam, metal alloys, aluminum, fabrics, and other materials may comprise some or all of the elements of the waste collection travel harness and apparatuses in various embodiments of the present invention.

Although the present invention has been illustrated and described herein with reference to preferred embodiments and specific examples thereof, it will be readily apparent to those of ordinary skills in the art that other embodiments and examples may perform similar functions and/or achieve like results. All such equivalent embodiments and examples are within the spirit and scope of the present invention, are contemplated thereby, and are intended to be covered by the following claims.

What is claimed:

1. A waste collection travel harness device for dogs that will collect fecal waste excreted by dogs. This device is suitable for dogs in the home, car, airplane, walking on the street, and any other place where they cannot excrete fecal waste without their owner being required to retrieve and discard said waste.

2. The disposable waste bag which is designed specifically to be secured to the elliptical opening 12.
